(19) United States
(12) Patent Application Publication
(10) Pub. No.: US 2020/0318600 A1
(43) Pub. Date: Oct. 8, 2020

(54) TRANSPORTABLE GRAVITATIONAL SYSTEM AND METHOD FOR GENERATING CONSISTENT ELECTRICAL POWER AND GENERATING MINIMIZED POLLUTION

(71) Applicant: LUIS WINTERGERST FISCH, GUADALAJARA (MX)

(72) Inventor: LUIS WINTERGERST FISCH, GUADALAJARA (MX)

(21) Appl. No.: 16/905,077

(22) Filed: Jun. 18, 2020

Related U.S. Application Data
(63) Continuation-in-part of application No. PCT/MX2017/000167, filed on Dec. 19, 2017.

(51) Int. Cl. F03B 13/08

(52) U.S. Cl. CPC F03B 13/086; F05B 2220/7064; F05B 2240/915; F05B 2270/1033; F05B 2210/11

(57) ABSTRACT

A transportable gravitational system and method for generating consistent electrical power and generating minimized pollution. The abstract of the disclosure is submitted herewith as required by 37 C.F.R. § 1.72(b). As stated in 37 C.F.R. § 1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/MX2017/000167, filed on Dec. 19, 2017. International Patent Application No. PCT/MX2017/000167 was pending as of the filing date of this application. The United States was an elected state in International Patent Application No. PCT/MX2017/000167.

### BACKGROUND

### 1. Technical Field

This invention has its technical development on the mechanical and electrical fields. Specifically, in a system and method to generate clean electrical power with an original gravitational mechanical system using air and water as a source of mechanical power generation. This is required to obtain enough radial movement and revolutions per minute to excite the synchronous alternator that generates a three-phase alternate current in a single closed and compact system.

### 2. Background Information

For centuries, man has used the force of the wind and water to move objects, ships, mills and machinery.

The application of the Archimedean principle has brought great benefits to navigation and to different systems that use buoyant force to obtain rotational mechanical force.

Archimedes' physical principle states that a body, wholly or partially immersed in a fluid at rest, receives a push from the bottom up equal to the weight of the volume of the fluid it displaces. This force is called hydrostatic or Archimedean thrust, and is measured in Newton (Nm).

Modern man's ambition to obtain energy derived from natural forces has generated countless developments and patents that use buoyant force to achieve specific objectives throughout centuries.

Mechanical Engineering or the Study of Mechanics involves the gravitational force that is denominated as “g” that is equivalent to 9.81 m/s².

The terrestrial gravitational force allows oceans and bodies of water to remain in the terrestrial position, which leads to the laws and physical principles that concern this development.

It is indeed, in the bodies or columns of water, where the flotation phenomenon takes place, which, when placing a container submerged with air, it receives a force proportional to the volume of water displaced inside it. When using water, the fluid density is equivalent to 1 gram/cm³=1000 kg/m³. It is important to point out that the density of water varies at different temperatures, expressed in kg/m³.

For Archimedes' formula of E=mpg, E=thrust; m=mass or volume of the container or volume of displaced water; p=fluid density; and g=terrestrial gravity.

Therefore, the thrust depends on the density of the fluid, the volume of the body and the existing gravity in that point in space. The thrust acts vertically with an upward force vector that is applied to the center of gravity of the body; this point is called Carena Center.

In some devices, the lifting bodies are filled with air and compressed by water pressure. Water is required for a filling and buoyancy blocking system. Additional energy to the buoyant body carried down. There should be a better force when rolling and lifting the surrounding float. Circulating bodies are guided between the floating bodies. In the inlet holes, the liquid flow exerts a pressure on flotation and it is carried at the lower pivot point of a liquid displacement in the rotating and ascending floating bodies of the water outlet openings. Floats can be filled there through a compressed air distributor housing with the side supply hole and fit, temporarily, the receiving intake with compressed air. Energy is obtained from mechanical drive of compressed air for a current generator.

In other devices, the lifting elements are filled with air and compressed by water pressure. Water from a sluice system is necessary for discharging and lifting. In addition, the energy is transmitted downwards. A better force action should be taken when rotating lifting bodies are raised and lifted. In addition, between the lowering chains of a lifting power plant, the floating bodies that sink in the liquid are also pulverized from below through a system to produce a rising gas blower mat with reinforcement of the intake. Mechanical drive energy is obtained for a compressed air generator.

These devices, to fill or inject the buckets with air, use the high-pressure system that requires more time. This is why the opportune effect of buoyancy and ascending vector force gets lost and they do not have any control over the speed of the transmission or the generation capacity of the system once the final electric charge is interconnected.

In addition, the buckets are only 50% filled as a maximum by using high pressure and injection pulses.

Likewise, such devices can only achieve a maximum of 400 rpm (revolutions per minute).

### OBJECT OR OBJECTS

An object of the present application is a device that overcomes the disadvantages of current devices.

### SUMMARY

In contrast to current and similar devices discussed above, an embodiment of the present application not only uses buoyant force from air in the metallic containers submerged in the water column suspended by a drive chain but also takes advantage of the mechanical force by using torque-multiplying sprockets and a mechanical transmission system. This increases the revolutions of the system in order to achieve enough drive speed that excites the central shaft of the synchronous alternator at 1,800 revolutions per minute (rpm) or less, depending on the type of alternator used.

The formula from which the radial torque increase derives is T=M*G*R, wherein T: Torque; M: Mass; G: Acceleration (gravitational); and R: Radius of the sprocket.

The torque of the system was doubled by increasing the radius of the installed master sprocket by 100%, which also facilitated the increase in revolutions that are delivered to the synchronous alternator of the system. The mass multiplied by the gravitational acceleration is equal to the weight or the upward force of our system.

Another way to express the radial torque would be T=D/2*F, wherein T: Torque; D: Diameter; and F: Force.

In addition, our system uses a speed control encoder that serves as a speed index, to track and monitor the speed required to keep steady revolutions per minute on the alternator. The speed control system uses information from an infrared sensor or encoder that detects the RPM of the alternator shaft, which will exactly reduce or accelerate the complete drive chain in order to obtain the perfect speed of the system interconnected to the alternator. By doing so, the three-phase voltage will always be constant and will be corrected in seconds when the electric charge of the interconnected equipment is on the in-rush process.

The invention requested is a mechanical-electrical system that uses a floatation system, a power transmission system that uses sprockets, pulleys, chains and timing belts, interconnected to an electric synchronous alternator. The system described uses as support systems: a vacuum pump that generates low-pressure air volume and the speed regulation motors, as well as the electrical control systems and electronic processors for the full control of the generation system.

This invention is the perfect solution for the growing demand for clean electrical power required by the industry, commerce, agriculture and housing requirements of the planet, generating constant energy and power which is reliable and adaptable for the power requirements of the power grid interconnected to the consumers at scales of 100 KWh to 100 MWh per site or specific generation project.

Exemplifications of the present application are described herein. It should be understood that when the words “invention” or “exemplification” are used in this specification, if at all, the words “invention” or “exemplification” include “inventions” or “exemplifications”, that is the plural of “invention” or “exemplification.” By stating “invention” or “exemplification,” if at all, the Applicant does not in any way admit that the present application does not include more than one patentably and non-obviously distinct invention or exemplification, and maintains that this application may include more than one patentably and non-obviously distinct invention or exemplification. The Applicant hereby asserts that the disclosure of this application may include more than one invention or exemplification, and, in the event that there is more than one invention or exemplification, that these inventions or exemplifications may be patentable and non-obvious one with respect to the other.

### BRIEF DESCRIPTION OF THE DRAWINGS

FIG. 1 illustrates the external steel structure, the metal walls that will serve to contain the water, the internal steel structure that supports different mechanical components of the system and the train drive, the drainpipe for water drainage as well as the electrical system that controls the mechanical drive of the invention.

FIG. 2 illustrates an internal view of the metal walls that will serve to contain the water column, as well as a view of the internal steel structure that holds different components inside the system and mechanism, the steel catwalk for operation and maintenance work.

FIG. 3 illustrates a view of the internal steel structure that holds inside different components of the system, mechanism and the steel floor. Not all the components are listed since the following figures will show them individually for a greater understanding.

FIG. 4 illustrates the conventional perspective of the lateral mechanical system, in which different components of the invention mechanism can be seen. It is important to have both perspectives in order to observe the different components of the mechanism in detail.

FIG. 5 illustrates conventional perspectives of the lower left side of the mechanical system, in which the different components of the invention mechanism can be seen. It is important to have both perspectives in order to observe the different components of the mechanism and specifically, the air outlet trident, which is located at the bottom of the tank.

FIG. 6 shows the conventional perspective of the left side that details all the components of the present invention mechanism, without the buckets that contain air for a better understanding of the mechanical system.

FIG. 7 shows the upper right side of the mechanical components of the invention, in which the power transmission system can be seen in more detail. It uses gears, sprockets, pulleys, chains and belts, as well as the motors that take part in the speed control of the train drive. The figure number in the upper perspective on the right-hand side corresponds to a vacuum pump, motors and sprockets; while the numbers on the upper perspective left side corresponds to the vacuum pump, motors, chains and belts.

FIG. 8 also shows an upper perspective from the left side to the upper mechanical components of the invention. Numbering is additional to the one in FIG. 7.

FIG. 9 also illustrates an upper perspective from the left side to the upper mechanical components of the invention, in which the power transmission drive can be seen in more detail. This system uses gears, sprockets, pulleys, chains and belts, as well as the motors that take part in the speed control of the system. Numbering is additional to the one indicated in FIGS. 7 and 8, and more focused on the different sprockets shafts that shape the present invention.

FIG. 10 illustrates an upper perspective from the right side to the upper mechanical components of the invention, such as the power transmission system that uses gears, sprockets, pulleys, chains and belts, as well as the motors involved. Numbering is additional to the ones indicated in FIGS. 7, 8 and 9.

FIG. 11 illustrates the air vacuum pump, as well as the PVC pipe through which air is sent to the bottom of the tank and into the buckets, with high efficiency.

FIG. 12 shows the exterior aspect of the electrical system.

FIG. 13 shows the components of the internal electrical system that are connected to the mechanical drive system.

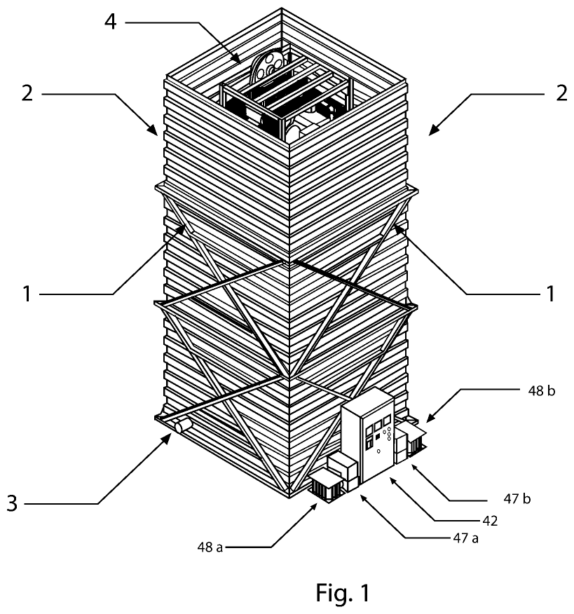

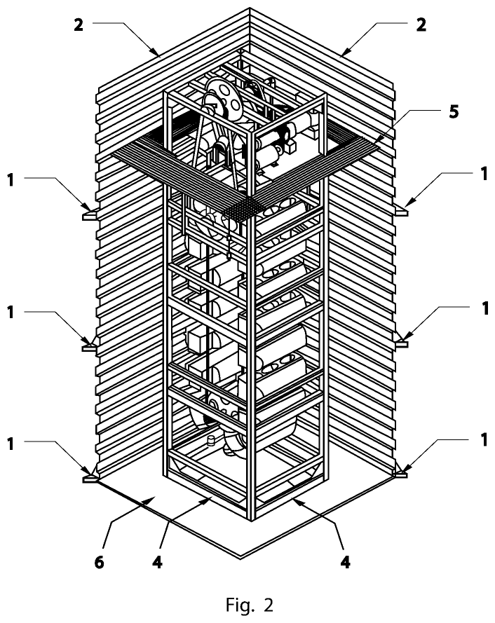

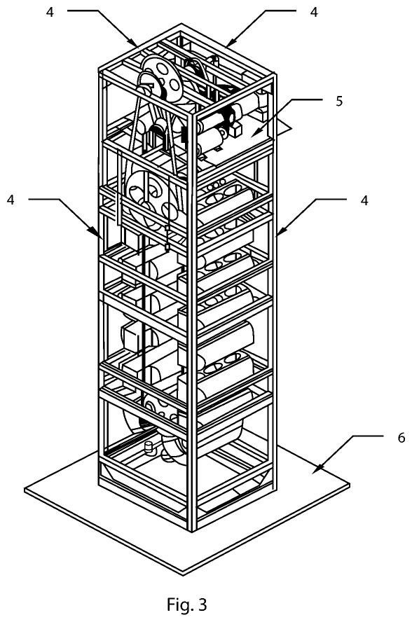

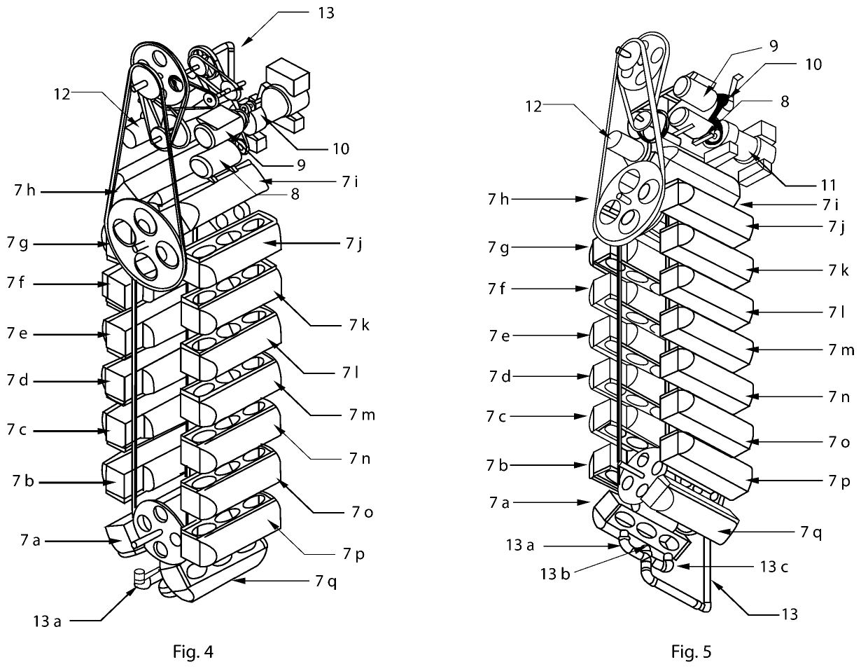

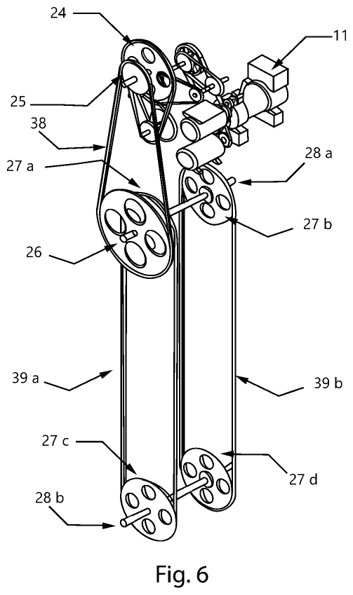

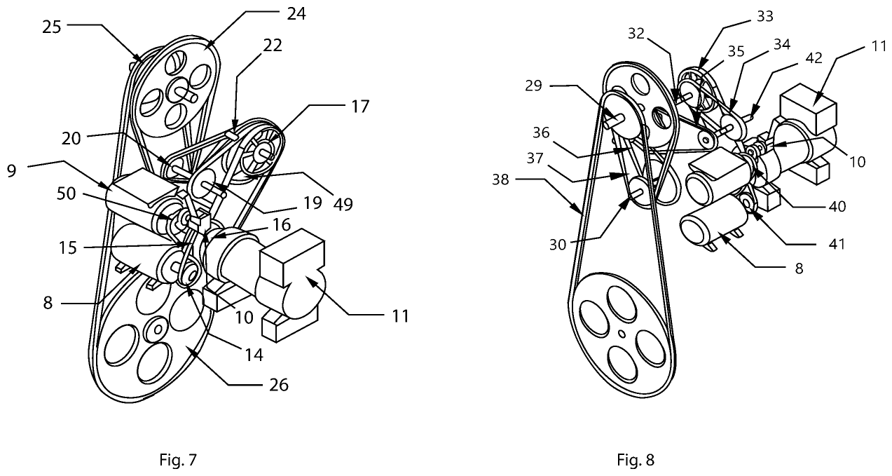

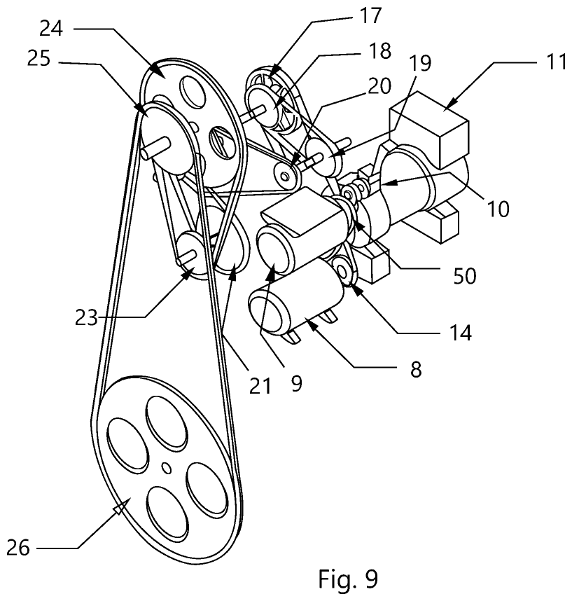

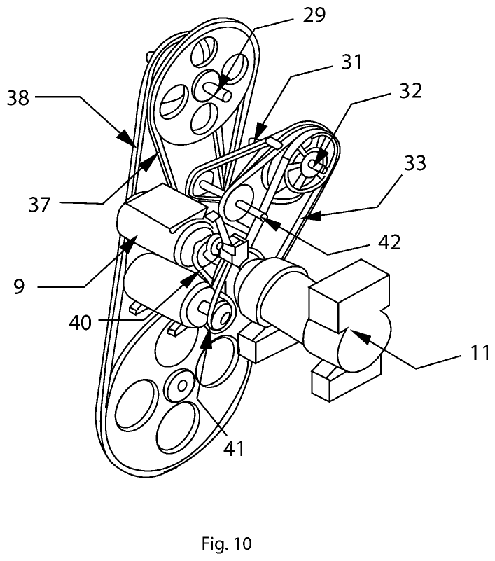

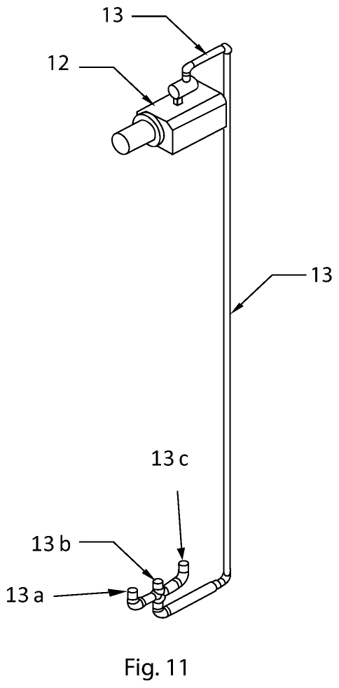

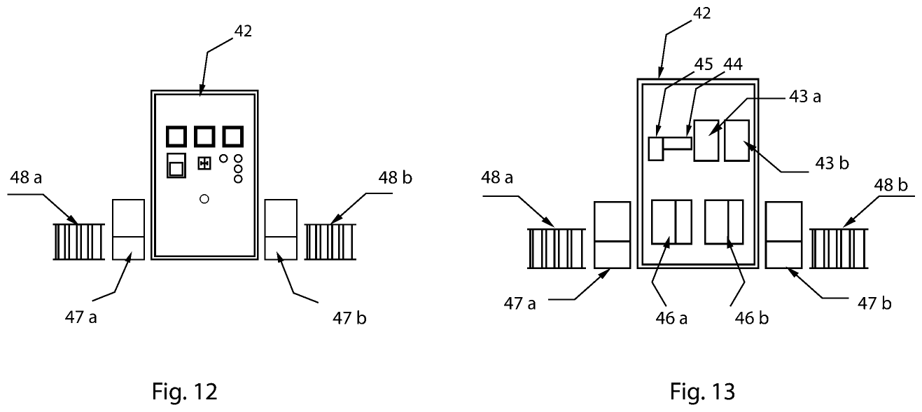

### DESCRIPTION OF EXEMPLIFICATION OR EXEMPLIFICATIONS

The characteristic details of this original transportable system and method for generating clean electrical power are clearly shown in the following description and the corresponding drawings, which follow the same reference signs to indicate the parts on the figures shown. Based on their description, the importance of each of the elements that shape the present invention will be deduced because without some of them, it would not be possible to operate the system at its maximum capacity and, consequently, it would not be possible to generate the constant and clean nominal electrical power that this system continuously generates.

Regarding such figures, the transportable system and method for generating clean electrical power must be carried out in a water container known as a hydraulic silo or a hydro-silo (2) that must be reinforced by an external steel structure (1) in order to contain the required water column that will rise two thirds of the walls of the hydro-silo (water container) (2) from bottom to top. In the center of the hydro-silo (water container) (2), an internal metal structure for the drive system (4) will be located on the steel floor (6) of the hydro-silo (water container) (2), which supports all the elements that shape the mechanical drive system of the present invention. At the bottom on either side of the hydro-silo (water container) (2), a drain or drainage (3) of the hydro-silo (water container) (2) was placed. Almost at the upper internal end of the water container (2), a steel catwalk (5) helps to walk around the machinery and maintain the mechanical and electrical components of the present invention that generates clean electrical power according to the sections a) to k) disclosed herein.

a) The system has two batteries (47a, 47b) and an electrical force board and control (42). These electrical switches inside the board (43a, 43b, 44, 45, 46a, 46b) such as frequency variations (VFD) (46a, 46b), a programmable logic controller (PLC) (44) and its power module (45) that is used as the electronic processor for controlling the motors (8,9) and the operating systems of the equipment, turns on and initialize the startup. The vacuum pump with air filter starts (12), which generates air volume with a pressure of 2 bar and a capacity of 140 m³ of air per hour.

The air generated through the vacuum pump with air filter (12) is sent to the bottom section of the mechanical system through a PVC (Polyvinyl Chloride) pipe, 2-inch diameter (13), with an air outlet and expansion with a 3-inch trident (13a, 13b, 13c). This directs the air volume to three different positions to transfer air volume to the buckets (7a-7q) to be filled approximately 90 to 98% of their capacity displacing the water out.

This air expansion system has a non-return valve (also known as “check valve”), which prevents water from flooding the PVC pipe in its horizontal and ascending section. By doing so, the drive trains achieve greater upward thrust immediately. Five seconds after starting the overall system, the vacuum pump (12) is energized and the drive process continues until all the buckets on the upward side are filled with air, thereby generating the greatest amount of buoyancy. This thrust is fully used to transmit the available radial torque through the mechanical power transmission system or train drive until reaching the alternator (11), excited at 1,800 RPM. (The system can use the internal deep cycle zinc bromide battery (47 a, and 47 (non-polluting) with 12 KWh capacity to start the system or, where appropriate, it can use external three-phase electric power, by means of the electric conduction through a heavy-duty cable to an external switch.

b) The simultaneous operation of a starter motor (9) and a primary speed control motor (8) begins; the starter motor (9) when reaching high revolutions (the full speed of the system for its operation is 1,800 to 2,000 rpm), automatically turns off and leaves only the primary speed control motor (8) ON, to normal operating conditions, delivering power and energy.

The primary speed control motor (8) that remains ON while the system is running is in charge of controlling the speed of the mechanical drive system. It is also in charge of ensuring that the bucket drive system (7a-7q, 26, 27a, 27b, 27c, 27d, 28a, 28b, 39a, 39 b) maintains its speed on the mechanical movement of ascension in the bucket drive chains (39a and 39b). Therefore, it manages higher or lower revolutions per minute (rpm), varying between 1800 and 2000 rpm as needed. The primary motor (8) performs the mechanical pilot or index function, since the drive system (26, 27a, 27b, 27c, 27d, 28a, 28b, 39a, 39b) is operating within its design operating range which is lower than the maximum bubble upward speed estimated at 25.5 cm/s.

This means that the primary speed control motor (8) sets the required speed at which the entire train drive system must operate (7a-7q, 26, 27a, 27b, 27c, 27d, 28a, 28b, 39a, 39b). It is powered by the underwater master sprocket (26) and since such speed is lower than the maximum ascending speed of the bubble, the motor drive system has the ability to speed up to meet the specific requirement by the primary speed control motor (8). The programmable logic controller of the system (PLC) (44) controls such motor and is protected with a thermodynamic switch (43a) which turns it ON as needed.

The constant nominal power generated can be 220V or 440V (240 to 480 Volts) interchangeably and previously set on the alternator before finishing the equipment installation.

Both motors (8 and 9) are interconnected by means of V-type belts through the drive pulleys (50 and 14 respectively) to the pulley installed on the main shaft of the alternator (40), meaning, a double V-type pulley to the alternator shaft. An Encoder (10) is installed on this shaft (it measures the speed of the alternator shaft in real time) that is interconnected to a programmable logic control (PLC) (44). It uses frequency inverters (46a and 46b) (VFD) and starters (43a, 43b) that turn the motors on or off, either to speed up and get higher speed or revolutions or turn them off in case any motors overheat (8, 9). One for the start regulator motor (9) and another for the primary speed control motor (8); when the speed of the alternator (11) decreases below 1800 rpm, the programmable logic controller (44) (PLC) executes variable acceleration commands (acceleration ramps) to compensate the electrical in-rush load and achieve the instantaneous revolutions per minute required by the synchronous alternator (11). If the primary speed control motor by itself (8), cannot generate the required rpm (revolutions per minute), the starter motor (9) controlled by the programmable logic control (PLC) accelerates it to support the motor primary speed control (8) to generate the required rpm (revolutions per minute). Therefore, once nominal speed is re-established the required regime of adequate operating generation sets to automatic, and the start-up regulator motors are left out of operation (9). When normal operating conditions have been reached, the generation process continues:

c) Air expelled from the trident (13a, 13b, 13c) or board to direct air volume to fill the buckets (7a-7q) with air, the process continues:

The volume of the air (bubbles) is conducted to the buckets with the air injection Trident (13a, 13b, 13c), the train drive experiences a thrust from the bottom to the top equivalent to the weight of the water displaced in all the buckets. Because of this thrust and the lower density of the bubble with respect to water, a vertical movement of upward translation occurs in the bucket drive chains (39a and 39b).

The total instantaneous air volume that is considered as all the air captured in the buckets (7a-7q) has an upward force that is converted into radial speed and torque. The results are the generation of electrical voltage (measured in Volts) according to the needs of the electrical installation receiving the power, having the speed index of the primary speed control motor (8) controlled by the programmable logic programmer (PLC) (44).

The buckets (7a-7q) could vary in terms of quantity and size, which increases or decreases the mechanical lift capacity through flotation and therefore, the overall drive system and the power generation capacity expressed in kWh (kilowatt hour).

Each bucket (7 a-7q) has a 1-inch high bubble leak barrier in the perimeter of the air volume intake that avoids loss of buoyancy and upward mechanical power by not allowing air to escape from the buckets (7 a-7q) during the ascent. Each bucket is fastened by a security fixing screw system and internal stainless-steel reinforcement plates.

d) The vertical parallel bucket chains (39a, 39b) are tightened by a screw system with proportional tension on both sides of the drive system; these chains (39 a, 39b) are tightened with:

e) A set of parallel drive sprockets (27a, 27b) (27c, 27d), installed on two horizontal shafts (28a, 28b), lower and upper, that, in the same shaft (28a) this connects with:

f) A set of sprockets (25, 26), where sprocket (26) is the master sprocket for power transmission to the upper drive system and the sprocket (25) is driven by primary power, tightened by a drive chain and master power conductor (38), which are the ones that transfer the available mechanical float power to the upper area of the machines, where, through gear ratio, gears with ratios from 1 to 3 (gear shift multiplier to increase 3 times the revolutions achieved by the master sprocket (26) in each step), it is possible to increase the rpm of the underwater drive shafts (28a-28b) to reach:

g) A set of sprockets (23, 24), where the sprocket (24) is secondary conductor and the sprocket (23) is power driven secondary, by means of a chain (37); the shaft (29) of the sprockets (24 and 25) is the same and by its movement, it continues to:

h) A set of sprockets (21-22), where the sprocket (21) is tertiary conductor and the sprocket (22) is driven tertiary and linked by a chain (36). The shaft (30) of the sprockets (21 and 23) is the same, and because of its movement, it continues to transmit mechanical force to:

l) A set of sprockets (20 and 49) where the sprocket (49) is quaternary conductor and the sprocket (20) is driven quaternary, linked by a chain (31), and because of their continuous movement, they transmit mechanical force to:

j) A set of sprockets (18 and 19) where the sprocket (19) is the fifth conductor and the sprocket (18) is fifth driven, linked by a chain (34), the shaft (42) of the sprockets (20 and 19) is the same, and because of its movement, it continues to transmit mechanical force to:

k) A set of high-speed timing gears (17), and a high-speed driven timing gear (16), installed on the shaft of the alternator (11) driven by a timing belt (33). At this point, the mechanical system concludes. It is also at this point, where the constant nominal three-phase electrical power has been generated and interconnected to the electrical installation that receives the power. (Power Distribution Board or Electrical Substation).

The present invention, called “Transportable Gravitational System and Method for Generating Clean Electrical Power” described in this document, has the following advantages over existing processes:

In principle, it is a reliable and autonomous system and method that uses Zinc Bromide (Br Zn) batteries (47a, 47b), the type of ecological batteries that have the ability to start and sustain the drive system without external three-phase electric current to generate constant nominal alternate power. It is important to point out that you can also use three-phase electric current to start the mechanical system. Once the system starts operating, it is capable of supporting itself without being connected to an electric line, since the synchronous alternator (11) has the capacity to continuously charge the batteries (47a, 47b) and condensers (48a, 48b) involved, and thereby establishes the Autonomous Constant Operating Regime (called “ROCA” by its acronym in Spanish).

The system works properly with such batteries (47a, 47b) because the synchronous alternator (11) recharges the batteries (47a, 47b) directly, by using a power inverter that delivers direct current (DC) to the batteries (47a, 47b) and capacitors (48a, 48b) so that there is always enough instantaneous electrical power available to keep the autonomous control system operating in the “ROCA” mode.

The control board (42) uses two variable frequency drives (46a and 46b), two batteries for storing electrical power (47a, 47b) as a supply for continuous electrical current (Amperage) to be able to start the equipment without any issues at all times. The programmable logic controller (PLC) (44) and its power module (45) are installed inside the board. Similarly, the system has starters (43a and 43b) to connect with the aforementioned speed control motors (8 and 9).

Other minor devices allow the proper operation of the equipment. However, they are not shown in the diagram since they are common electrical and electronic devices.

Likewise, the system has included a redundant electrical device in its design, using super Capacitors (48a, 48b) with instantaneous capacity to deliver 60 Volts and 165 Faradays. These capacitors (48a, 48b) are always charged in case the batteries (47a, 47b) do not have enough stored charge for immediate response.

Once the alternator achieves a nominal generation regime, such batteries (47a, 47b) charge immediately and provides support for the electrical feedback required by the speed control system mentioned before.

This system and method of generating clean power ensures an instantaneous start even when the optimum water level is not available for its best performance. The start of electrical power generation is achieved between 5 and 15 seconds after starting the bucket filling process (7a-7q) with air, and the upward movement of the mechanical drive system is achieved.

The system in question has a minimum energy efficiency of 86% when exciting the synchronous alternator (11) of 1,800 rpm (revolutions per minute) with the use of a single primary speed control motor (8) connected in 220V or 440V, to regulate the system speed for the electrical power generation through the synchronous alternator (11).

It obtains 25,000 lb.-in (pound force inch) in a hydro-silo (2) or container, with a capacity of 5 m of water column.

The vacuum pump with air filter (12) sucks in atmospheric air and generates 2 bars of pressure. It is delivered through a PVC pipe (13) in a trident shape (13a, 13b, 13c) to the lower part of the hydro-silo (2). It transfers the volume of air to the metal containers or buckets (7a-7q) in order to exert the upward buoyant force required for the mechanical movement of the bucket drive chains (39a and 39b) of the system. This vacuum pump (12) is also a mechanical system that uses an electric AC motor and generates rotary motion for its operation.

The vacuum pump (12) uses the energy of the internal generation system at 440V since this system is required to fill with air (7a-7q) the buckets drive chain (39a, 39b), on the upward side. The number of buckets is variable and depends on the generation capacity required by the system to be manufactured.

It manages to transmit the available mechanical buoyancy power to the upper area of the system, where, through gear ratios from 1 to 3 (gear shift multiplier to increase 3 times the revolutions achieved by the master sprocket (26)), it is possible to increase the rpm of the underwater drive shafts (28a and 28b). As a result, the alternator (11) achieves the revolutions required to generate alternate power.

This invention considers a specific mechanical transmission design (through the gears transmission system embedded on the system), under which, it is possible to increase the revolutions per minute (RPM) of the submarine sprockets (27a, 27b, 27c, 27d). It means a 1:300 ratio to achieve alternator nominal speed of 1,800 RPM or more. The invention uses sprockets, chains, pulleys and belts; however, they can be replaced with a custom-made speed multiplier gearbox instead, to achieve the speed regime on 1,800 RPM.

The buckets (7a-7q) of the downward drive chains (39a and 39b) get flooded with water to generate a zero balance of dynamic loads and allow the air trapped in the upward system to generate enough upward vector force to obtain mechanical torque that will be converted based on mechanical ratio iteration of 1 to 3, until transmitting enough revolutions per minute (rpm) to excite the alternator (11) in question. The volume of air present in the buckets, which is equivalent to the volume of water displaced, generates a force equivalent to 1 kg for each liter of water displaced, taking into consideration that the density of water is equivalent to 1.

The invention manages to avoid the floating effect of the descending buckets by means of level sensors that ensure the appropriate amount of water column, controlled by the PLC (44) of the control board. In this way, the buckets are always immersed under the water level and the flotation that is unfavorable in this specific system is avoided. This system takes full advantage of the buoyant force of the bubbles or the volume of air suspended or trapped on the aquatic drive system.

The primary speed regulator motor (8) is an electrical system, like the motor of the vacuum pump (12) and the synchronous alternator (11). Such systems are interconnected to the mechanical transmission of the generation system to provide enough instantaneous supplementary torque to keep the alternator (11) within the nominal speed rate. This capacity is available with alternate electric current on 220 v or 440 v efficiently, even when there are external motors, pumps or electrical equipment interconnected with peak demand requirements during the in-rush motor startups. This starting power requirement (in-rush) varies between 2 or 3 times the nominal operating amperage during the first seconds of the start-up of such equipment, and it is precisely during this period of time that the gravitational system has the ability to accelerate and balance this peak power demand.

This invention has a speed regulating system that ensures that the revolutions per minute (RPM) of the alternator (11) and the electrical power generated, is always within a close range. This fact distinguishes it from the rest of the patents and similar equipment, since we can guarantee the quality of the constant nominal energy and electrical power generated, for industrial users like, computing, telecommunications, commercial, housing, mining, agro-industry, coastal, national emergencies, and planetary exploration among others.

The sophisticated speed control system of this invention is a significant technological advance, without which, all similar systems that use floatation cannot maintain the revolutions per minute (rpm) when connecting equipment whose startups require additional power and, therefore, the level of instantaneous generated voltage by the generation system would be significantly reduced (frequency range mismatch).

This system is transportable because the entire mechanical system is located in the hydro-silo (water container) (2) and, when it is dry empty, it can easily be transported by land, air or sea, without being separated into pieces or dismantled. The weight of such dry assembly is 8 tons.

On the other hand, this system operates with a low noise level since it uses timing belts (33) and high-speed pulleys (16, 17), and, therefore, noise levels in decibels are lower than 72 dB in the lower operational level of the system and lower than 93 dB in the higher section of the system.

The system uses membranes that allow atmospheric pressure to enter the hydro-silo (2), but prevent moisture from escaping from the container. Likewise, the equipment always has a drip makeup system to balance any accumulated evaporation in long periods of accumulated operation.

This transportable gravitational system and method for generating clean electrical power, must be carried out inside a hydro-silo (water container) (2), with two-thirds of steel reinforcement (1) starting from the bottom upwards, with a drain (3) for the water it requires, the steel frame (4) that supports the mechanical system on the steel floor (6). The hydro-silo (water container) (2) will contain 5 m of water column inside, almost at the upper internal end of the hydro-silo (2) (water container), it contains a catwalk (5) around the machinery that is used to maintain the mechanical and electrical components of the present invention.

It is of utmost importance that the system has a speed regulator motor for the start-up (9) and a primary speed control motor (8). V-type belts interconnect these two motors (8 and 9) through the drive pulleys (50 and 14 respectively) to the pulley installed on the alternator shaft (40). The vacuum pump (12) supplies a high volume of air through a PVC pipe (13) and it is delivered to the buckets (7a-7q) at the bottom of the system with an air injection trident (13a, 13b, 13c). This air injection, quickly and completely, fills the buckets arranged on the upward side of the hydro-silo (7a-7q), the vertical parallel bucket chains (39a, 39b) are tightened through a screw system with proportional tension on both sides of the drive system. The mechanical system starts with the movement of the master sprocket (26) in order to transmit power to the upper transmission system and the primary drive sprocket (25) tightened by a transmission chain and the master power driver (38). Through gear ratios, gears or gearboxes with ratios of 1 to 3 (change of multiplying gear to increase 3 times the revolutions achieved by the master sprocket (26)), it is possible to increase the revolutions per minute (RPM) of the underwater drive shafts (28a, 28b). This shaft (28a) is the same for the sprockets (27a, 27b and 26).

Afterwards, a set of sprockets (23, 24), where the sprocket (24) is secondary conductor and the sprocket (23) is secondary driven power, by means of a chain (37). The shaft (29) of the sprockets (24 and 25) is the same and provides movement to a set of sprockets (21-22), where the sprocket (21) is tertiary conductor and the sprocket (22) is driven tertiary and connected by a chain (36). The shaft (30) of the sprockets (21 and 23) is the same; a set of sprockets (20 and 49) where the sprocket (49) is quaternary conductor and the sprocket (20) is quaternary driven, linked by a chain (31). Another set of sprockets (18 and 19) where the sprocket (19) is fifth conductor and the sprocket (18) is fifth driven, linked by a chain (34). The shaft (42) of the sprockets (20 and 19) is the same. Finally, a set of high-speed timing gears (17), and a high-speed driven timing gear (16), which in turn connects to the shaft of the alternator (11) and provides movement to a timing belt (33). At this point, the description of the mechanical system concludes and it is at that precise moment when the constant nominal three-phase electric power has been achieved and it is transmitted to the electrical installation (power distribution board or electrical substation).

In combination with the mechanical system, this invention uses a sophisticated electrical control system that includes a control board (42), thermo-magnetic switches (43a and 43b), programmable logic controller (PLC) (44) and a power module (45) to start. It uses electrical energy stored in batteries (47a, 47 b) and capacitors (48a, 48b), which also include frequency inverters (VFD) (46a and 46b) connected to the motors (8 and 9) and energize the vacuum pump with air filter (12). The vacuum pump supplies a high volume of air and quickly and completely fills the buckets (7i-7q) arranged on the upward side, which, due to the principle of Flotation of Archimedes, receive an upward force of 1 kg of force for each liter of displaced water.

Such mechanical force, accumulated in the underwater master sprocket (26), transmits the radial torque to a sophisticated system of gear ratios that increase the number of revolutions per minute of the transmission to excite the range of the synchronous alternator at 1,800 to 2,000 RPM (11). The gear ratios can be simplified using a custom-made speed multiplier gearbox interconnected to the alternator shaft.

The electrical control system uses frequency inverters (VFD) to control 3 motors: the vacuum pump motor with air filter (12), the starter motor (9) and the primary speed control motor (8).

These pieces of equipment use the energy from the capacitors (48 a, 48 b) and batteries (47a, 47 b), to achieve the operating regime of the synchronous alternator (11), achieving in 10 seconds, the generation of alternate power at 220V or 440V. When the synchronous alternator (11) receives the load or power requirement through the interconnection to the target distribution boards (42), the autonomous control system accelerates the train drive chain system, with which the synchronous alternator (11) always delivers the same constant nominal voltage to the boards (42) with the instantaneous peak load, ensuring uninterrupted power supply with regulated voltage on site.

The system achieves, by means of the sophisticated system of gear shifts or a custom-made gearbox, higher revolutions per minute (RPM) of the underwater train drive system (25, 26) in a substantial way until it achieves the required nominal speed of 1,800 rpm as minimum.

The equipment has integrated a peak power demand tracking module to be able to compensate the speed changes of the synchronous alternator (11), generated by a peak demand of electrical power, and an encoder (10) that measures the instantaneous speed of the alternator shaft (11).

The equipment is fully portable, since it has a water drain (3) with which, the system can be emptied in minutes and quick disconnects clamps from the distribution board (42) to the internal power panels.

The water used inside the container or hydro-silo (water container) (2) is reusable and does not require to be potable; once every 3 years (in fixed installations) the water can be drained and sent through hoses to a non-polluting effluent treatment transport pipe.

One feature or aspect of an exemplification is believed at the time of the filing of this patent application to possibly reside broadly in a transportable gravitational system for generating clean electrical power which is carried out inside a hydro-silo (water container) (2), with two-thirds of steel reinforcement (1) starting from the base upwards, with a drain (3) for the water. The hydro-silo (2) will have an internal steel structure (4) that supports the mechanical system on the steel floor (6); the hydro-silo (water container) (2) will contain 5 m of water column inside. Almost at the upper internal end of the hydro-silo (2) (water container) there is a horizontal catwalk (5) around the internal metal structure (4) to carry out maintenance work on the mechanical and electrical components of the present invention. This method has two batteries (47a, 47b) and an electrical force and control board (42). Through the electrical switches inside the board (43a, 43b, 44, 45, 46a, 46b) such as, frequency inverters (VFD) (46a, 46b), a programmable logic controller (PLC) (44) and its power module (45) used as the electronic processor of motor control (8,9) and operational equipment systems. The system turns ON and begins the startup, initializing with the vacuum pump with air filter (12). The air generated through the vacuum pump with air filter (12) is sent to the bottom part of the mechanical system through a PVC (Polyvinyl Chloride) pipe, 2-inch diameter (13). It has a non-return valve that prevents water from flooding the PVC pipe in its horizontal and ascending section, with air outlet and expansion section in a 3-inch trident (13a, 13b, 13c). This air injection, quickly and completely, fills the buckets arranged on the upward side of the hydro-silo (7a-7q). The vertical parallel bucket chains (39a, 39b), tightened by a screw system with proportional tension on both sides of the drive system, completes the start of the mechanical system with the movement of the master sprocket (26) so that it transmits the power to the upper transmission system. The sprocket (25) driven by primary power, is driven by a transmission chain and a master power conductor (38). The gear ratio, gears or gearbox with ratios from 1 to 3 (change of multiplying gear) to increase 3 times the revolutions achieved by the master sprocket (26), increase the revolutions per minute (RPM) of the underwater drive shaft (28a, 28b). The shaft (28a) is the same for the sprockets (27a, 27b and 26); afterwards, a set of sprockets (23, 24), where the sprocket (24) is secondary conductor and the sprocket (23) is secondary driven power, by means of a chain (37). The shaft (29) of the sprockets (24 and 25) is the same and provide movement to a set of sprockets (21-22), where the sprocket (21) is tertiary conductor and the sprocket (22) is driven tertiary and connected by a chain (36). The shaft (30) of the sprockets (21 and 23) is the same; a set of sprockets (20 and 49) where the sprocket (49) is a quaternary conductor and the sprocket (20) is quaternary driven, linked by a chain (31). Another set of sprockets (18 and 19) where the sprocket (19) is fifth conductor and the sprocket (18) is fifth driven, linked by a chain (34). The shaft (42) of the sprockets (20 and 19) is the same. A set of high-speed timing gears (17), and a high-speed driven timing gear (16), installed on the shaft of the alternator (11) that provides movement to a timing belt (33). At this point is where the constant nominal three-phase electrical power has been generated and is transmitted with an interconnection the electrical panel a power distribution board or electrical substation. In combination with the mechanical system, this invention uses a sophisticated electrical control system that includes a control board (42), starters (43a and 43b), programmable logic controls (PLC) (44) and its power module (45) to start. It uses electrical energy stored in batteries (47a, 47 b) and capacitors (48a, 48b), which also include frequency inverters (VFD) (46a and 46b) connected to the motors (8 and 9) and energize the vacuum pump with air filter (12). The vacuum pump supplies a high volume of air and quickly and completely fills the buckets (7i-7q) arranged on the upward chain drive.

One feature or aspect of an exemplification is believed at the time of the filing of this patent application to possibly reside broadly in a transportable gravitational method for generating clean electrical power, is characterized by operating within a hydro-silo (water container) (2), with two-thirds of steel reinforcement (1) starting from the base upwards, with a drain (3) for water. The hydro-silo (2) will contain an internal steel structure (4) that supports the mechanical system on the steel floor (6); the hydro-silo (water container) (2) will contain 5 m of water column inside. Almost at the upper internal end of the hydro-silo (2) (water container) there is a horizontal catwalk (5) around the internal metal structure (4) to carry out maintenance work on the mechanical and electrical components of the present invention. This method has two batteries (47a, 47b) and an electrical force and control board (42), which through the electrical switches inside the board (43a, 43b, 44, 45, 46a, 46b) such as, the frequency inverters (VFD) (46a, 46b), a programmable logic controller (PLC) (44) and its power module (45) used as the electronic processor of the motor control (8,9) and operational equipment systems. The system turns ON and begins the startup, initializing with the vacuum pump with air filter (12). The air generated through the vacuum pump with air filter (12) is sent to the bottom part of the mechanical system through a PVC (Polyvinyl Chloride) pipe, 2-inch diameter (13). It has a non-return valve that prevents water from flooding the PVC pipe in its horizontal and ascending section, with air outlet and expansion section in a 3-inch trident (13a, 13b, 13c). This air injection, quickly and completely, fills the buckets arranged on the upward side of the hydro-silo (7a-7q). The vertical parallel bucket chains (39a, 39b), tightened by a screw system with proportional tension on both sides of the drive system, complete the start of the mechanical system with the movement of the master sprocket (26) so that it transmits the power to the upper transmission system. The sprocket (25) driven by primary power, is driven by a transmission chain and a master power conductor (38). The gear ratio, gears or gearbox with ratios from 1 to 3 (multiplying gear) to increase 3 times the revolutions achieved by the master sprocket (26), increase the revolutions per minute (RPM) of the underwater drive shaft (28a, 28b). The shaft (28a) is the same for the sprockets (27a, 27b and 26); afterwards, a set of sprockets (23, 24), where the sprocket (24) is secondary conductor and the sprocket (23) is secondary driven power, by means of a chain (37). The shaft (29) of the sprockets (24 and 25) is the same and provide movement to a set of sprockets (21-22), where the sprocket (21) is tertiary conductor and the sprocket (22) is driven tertiary and connected by a chain (36) to the shaft (30) of the sprockets (21 and 23) that is the same. A set of sprockets (20 and 49) where the sprocket (49) is a quaternary conductor and the sprocket (20) is quaternary driven, linked by a chain (31). Another set of sprockets (18 and 19) where the sprocket (19) is fifth conductor and the sprocket (18) is fifth driven, linked by a chain (34). The shaft (42) of the sprockets (20 and 19) is the same. A set of high-speed timing gears (17), and a high-speed driven timing gear (16), installed on the shaft of the alternator (11) that provides movement to a timing belt (33). At this point, the description of the mechanical system concludes. It is also at this point, where the constant nominal three-phase electrical power has been generated and is transmitted with an interconnection to the electrical panel (power distribution board or electrical substation). In combination with the mechanical system, this invention uses a sophisticated electrical control system that includes a control board (42), starters (43a and 43b), programmable logic controls (PLC) (44) and its power module (45) to start. It uses electrical energy stored in batteries (47a, 47 b) and capacitors (48a, 48b), which also include frequency inverters (VFD) (46a and 46b) connected to the motors (8 and 9) and energize the vacuum pump with air filter (12). The vacuum pump supplies a high volume of air and quickly and completely fills the buckets (7i-7q) arranged on the upward chain drive.

One feature or aspect of an exemplification is believed at the time of the filing of this patent application to possibly reside broadly in the method wherein the primary speed regulator motor (8), is an electrical system, like the motor of the vacuum pump (12) and the synchronous alternator (11). Such systems are interconnected to the mechanical transmission of the generation system to provide enough instantaneous supplementary torque to keep the alternator (11) within the nominal speed rate. This capacity is available even when there are motors, pumps or electrical equipment interconnected with high requirements during the in-rush startups. This starting power requirement (in-rush) varies between 2 or 3 times the nominal operating amperage during the first seconds of the start-up of such equipment, and it is precisely during this period of time that the gravitational system has the ability to accelerate and balance this peak power demand.

One feature or aspect of an exemplification is believed at the time of the filing of this patent application to possibly reside broadly in the system, which contains a speed regulating system with feedback and ensures the required revolutions per minute (RPM) on the alternator (11) and, therefore, the electrical power generated, tends to be the constant, with a 1-5 second timing for the recovery ramp.

One feature or aspect of an exemplification is believed at the time of the filing of this patent application to possibly reside broadly in the method, which uses Zinc Bromide (Br Zn) batteries (47a, 47b), the type of ecological (non-polluting) batteries that have the ability to start and sustain their own system without external three-phase electric power to generate constant nominal alternate current. It is important to point out that you can also use three-phase electric current to start the mechanical system. Once the system starts operating, it is capable of supporting itself without being connected to any electric source, since the synchronous alternator (11) has the capacity to continuously charge the batteries (47a, 47b) and condensers (48a, 48b) involved and thereby establishes the Autonomous Constant Operating Regime (called ROCA).

One feature or aspect of an exemplification is believed at the time of the filing of this patent application to possibly reside broadly in the method, in which the control board (42) uses two variable frequency drives (46a and 46b), two batteries to store electrical power (47a, 47b) in order to generate electrical power (amperage) continuously and always be able to start the equipment without any issues under any weather condition. The programmable logic controller (PLC) (44) and its power module (45) are installed inside the electrical panel. Likewise, the system has starters (43a and 43b) to connect with the previously mentioned speed control motors (8 and 9) that are operated by the aforementioned variable frequency drives (VFD).

One feature or aspect of an exemplification is believed at the time of the filing of this patent application to possibly reside broadly in the method, which ensures an instantaneous start even when the optimum water level is not available for its best operation and the start of electric power generation is achieved between 5 and 15 seconds after starting the air volume filling process (7a-7q) with air, and the upward movement of the mechanical system started.

One feature or aspect of an exemplification is believed at the time of the filing of this patent application to possibly reside broadly in the method, which has 86% energy efficiency when exciting a synchronous alternator (11) of 1,800 rpm (revolutions per minute) with the use of a single primary speed control motor (8) connected to 220V or 440V in order to regulate the speed of the electric power of the synchronous alternator (11).

One feature or aspect of an exemplification is believed at the time of the filing of this patent application to possibly reside broadly in the method, in which the vacuum pump with air filter (12), sucks in atmospheric air, generating 2 bars of pressure, and delivers it through a PVC pipe (13), in a trident shape (13a, 13b, 13c) to the lower part of the hydro-silo (2). Here, it transfers the volume of air to the metal containers or buckets (7a-7q), to exert the upward buoyant force required for the mechanical movement of the bucket drive chains (39a and 39b) of the system, and the buckets internal volume (7a-7q) fills approximately 90 to 98% of their capacity. This vacuum pump (12) is also a mechanical system that uses an electric motor with rotary motion required for its operation, the vacuum pump (12) uses the energy of the internal generation system at 440V, since such system is required to fill with air the buckets (7a-7q) of the drive chain (39a, 39b) on the upward side. The number of buckets is variable because it depends on the generation capacity required by the system to be manufactured.

One feature or aspect of an exemplification is believed at the time of the filing of this patent application to possibly reside broadly in the method, that transfers all the available mechanical power of flotation to the upper section of the machine. It is possible, through gear ratios, gears or gearbox with ratios from 1 to 3 (change of multiplying gear to increase 3 times the revolutions achieved by the master sprocket (26)), to increase the rpm of the underwater drive shafts (28a and 28b) consistently until the alternator reaches (11) the revolutions required to generate alternate current with the required voltage. This invention considers a specific mechanical transmission design, under which, it is possible to increase the revolutions per minute (RPM) of the underwater sprockets (27a, 27b, 27c, 27d). It means a 1:300 ratio to achieve alternator nominal speed of 1,800 RPM or more. The invention uses sprockets, chains, pulleys and belts; however, they can be replaced with a custom-made speed multiplier gearbox instead, to achieve the speed regime on 1,800 RPM.

One feature or aspect of an exemplification is believed at the time of the filing of this patent application to possibly reside broadly in the method, which achieves the downward side buckets (7a-7q) of the bucket drive chains (39a and 39b) get flooded with water to generate a zero balance of dynamic loads. This will allow the air trapped in the upward drive system to generate enough upward vector force to obtain mechanical torque that will be converted based on mechanical ratio changes 1 to 3 per interaction, to increase the output speed revolutions per minute (rpm) to excite the alternator on 220 or 440 Volts (11).

One feature or aspect of an exemplification is believed at the time of the filing of this patent application to possibly reside broadly in the method, in which, each bucket (7 a-7q) has a 1-inch high bubble leak barrier within the perimeter of air volume intake to avoid loss of buoyancy and upward mechanical power by not allowing air to escape from the buckets (7 to-7q) while ascending. Each bucket is fastened through a security fixing screw system and stainless-steel internal reinforcement plates. The buckets (7a-7q) could vary in terms of quantity and size, which increases or decreases the mechanical lift capacity through flotation and therefore, the integral drive system and the power generation capacity expressed in KWh (kilo watts' hour).

One feature or aspect of an exemplification is believed at the time of the filing of this patent application to possibly reside broadly in the method, which manages to avoid the flotation of the descending buckets through level sensors that ensure the appropriate level of water column, controlled by the PLC (44) on the control board. Consequently, the buckets are always immersed under the water level and the flotation that is unfavorable in this specific system is avoided. The system takes full advantage of the buoyant force of the bubbles or the volume of air suspended or trapped inside the buckets.

One feature or aspect of an exemplification is believed at the time of the filing of this patent application to possibly reside broadly in the method, in which the motor speed control system can maintain the required revolutions per minute (rpm) when connecting equipment whose start-ups in-rush requires additional power. Therefore, the level of Instantaneous Generated Voltage will remain within close range to 440V or 220V of recover as quickly as possible (1 to 5 seconds) relying on the automated PLC internal speed control.

One feature or aspect of an exemplification is believed at the time of the filing of this patent application to possibly reside broadly in the method, which, when it is turned ON, it starts the simultaneous operation of a starter regulator motor (9) and a primary speed control motor (8). The starter motor (9) when reaching high revolutions (the full speed of the system for its operation is 1,800 to 2,000 rpm), automatically turns off, leaving the primary speed control motor (8) ON for normal operating conditions, delivering power and energy. The primary speed control motor (8) that remains ON while the system is running, is the one that controls and monitors the speed of the mechanical system. It also ensures the bucket drive system (7a-7q, 26, 27a, 27b, 27c, 27d, 28a, 28b, 39a, 39b) maintains its constant speed on the mechanical movement of ascension in the bucket drive chains (39a and 39b). Therefore, it manages higher or lower revolutions per minute (rpm), varying between 1800 and 2000 rpm as needed. The primary motor (8) performs the mechanical guide or index function, since the bucket drive system (26, 27a, 27b, 27c, 27d, 28a, 28b, 39a, 39b) is within the operating range which is slower than the bubble upward speed which is estimated to be at 25.5 cm/s maximum.

One feature or aspect of an exemplification is believed at the time of the filing of this patent application to possibly reside broadly in the method, wherein both motors (8 and 9) are interconnected by means of V-type belts through the drive pulleys (50 and 14 respectively) to the pulley, which is installed on the alternator shaft (40), that is, a double V-type pulley on the shaft of the alternator. An encoder (10) is installed on this shaft (it measures the speed of the alternator arrow in real time) and interconnected to a programmable logic control (PLC) (44). It uses frequency inverters (46a and 46b) (VFD) and starters (43a, 43b) that turn the motors ON or OFF, either to generate more revolutions or turn them off once the ROCA Regime has been reached or when the additional load is normalized (8, 9). One for the start regulator motor (9) and another for the primary speed control motor (8); when the speed of the alternator (11) decreases below 1800 rpm, the programmable logic controller (44) (PLC) executes variable acceleration commands (acceleration ramps) to compensate the electrical load and achieve the instantaneous revolutions per minute required by the synchronous alternator (11). If the primary speed control motor by itself (8), cannot generate the required rpm (revolutions per minute), the starter motor (9) controlled by the programmable logic control (PLC) starts an acceleration ramp to support the primary speed control motor (8) to generate the required rpm (revolutions per minute). Therefore, operating regime is established again and the automatic mode is restored. Then the start-up regulator motor (9) is out of operation when normal operating conditions have been reached.

One feature or aspect of an exemplification is believed at the time of the filing of this patent application to possibly reside broadly in the method, in which the volume of total instantaneous air that is considered as all the air captured in the buckets (7a-7q), has an upward force that is converted into radial speed and torque. The results are the generation of electrical voltage (measured in Volts) according to the needs of the electrical installation receiving the power, having the speed index of the primary speed control motor (8) controlled by the programmable logic programmer (PLC) (44).

One feature or aspect of an exemplification is believed at the time of the filing of this patent application to possibly reside broadly in the method, wherein the system is transportable since the entire mechanical system is located inside the hydro-silo (water container) (2), and when it is empty dry, it can easily be transported by land, air or sea, without being separated into pieces or dismantled. The weight of such dry assembly is 8 tons.

One feature or aspect of an exemplification is believed at the time of the filing of this patent application to possibly reside broadly in the method, wherein the system manages to operate with a low operational noise level since it uses timing belts (33) in the high-speed pulleys (16, 17). In this way, noise levels in decibels are lower than 72 dB in the lower part of the system and lower than 93 dB in the higher part of the system.

One feature or aspect of an exemplification is believed at the time of the filing of this patent application to possibly reside broadly in the method, wherein the system uses membranes that allow atmospheric pressure to enter the hydro-silo (2), but prevent moisture from escaping from the container. Likewise, the equipment always has a drip makeup water system to compensate any accumulated evaporation in long periods of accumulated operation.

One feature or aspect of an exemplification is believed at the time of the filing of this patent application to possibly reside broadly in a transportable gravitational system for generating clean electrical power which is carried out inside a hydrosyl (water container) (2), with a metal reinforcement (1) starting from a base of the water container (2) upwards, and with a drain (3) for the water; the hydrosyl (2) comprising an internal steel structure (4) that supports said mechanical system on a steel floor (6); the hydrosyl (water container) (2) being configured to contain up to 5 meters of water column inside the hydrosyl (2); adjacent an upper internal end of the hydrosyl (2) (water container) is disposed a horizontal catwalk (5) around the internal metal structure (4) configured to carry out maintenance work on the mechanical and electrical components of said system; said system comprises two batteries (47a, 47b) and an electrical power and control board (42); electrical switches inside a board (43a, 43b, 44, 45, 46a, 46b), comprise at least one of: frequency inverters (VFD) (46a, 46b), a programmable logic controller (PLC) (44); and power module (45) for the programmable logic controller (PLC) (44) and configured as the electronic processor of a motor control (8,9) and operational equipment systems; the system is configured to be turned ON and begins a startup, and configured to be initialized with a vacuum pump which includes an air filter (12), the vacuum pump with the air filter (12) being configured to supply air to a bottom part of the mechanical system through a Polyvinyl Chloride pipe (13); the pipe comprises a non-return valve that prevents water from flooding the PVC pipe in the pipe's horizontal and ascending sections, the pipe comprises an air outlet and expansion section in a trident (13a, 13b, 13c); the trident is configured to fill the buckets disposed on an upwardly moving side portion of the hydrosyl (7a-7q), the vertical parallel bucket chains (39a, 39b), being configured to be tightened by a screw system with proportional tension on both sides of the drive system, the mechanical system comprising a starting arrangement to move the master sprocket (26) so that the master sprocket is configured to transmits the power to the upper transmission system; the sprocket (25) configured to be driven by primary power, is configured to be driven by a transmission chain and a master power conductor (38); the gear ratio, gears or gearbox comprising gear ratios of approximately or exactly 1 to 3 which gear ratios are configured to increase by about 3 times the revolutions achieved by the master sprocket (26), wherein an increase in the revolutions per minute (RPM) of the underwater drive shaft (28a, 28b) results; the shaft (28a) is configured to operate the sprockets (27a, 27b and 26); a set of sprockets (23, 24) connected to transmit power, wherein the sprocket (24) is a secondary conductor of power and the sprocket (23) is a secondary driven conductor (24) of power, with both the sprocket (23) and the sprocket (24) being configured to be driven by means of a chain (37); the shaft (29) of the sprockets (24 and 25) is configured to provide movement to a set of sprockets (21-22), wherein the sprocket (21) is a tertiary conductor of power and the sprocket (22) is a driven tertiary conductor of power driven by means of a chain and both the sprocket (21) and the sprocket (22) being connected by a chain (36); the shaft (30) being configured to drive the sprockets (21 and 23); a set of sprockets (20 and 49) where the sprocket (49) is a fourth conductor power source and the sprocket (20) is a fourth driven sprocket; both the sprocket (49) and the sprocket (20) being linked by a chain (31); a further set of sprockets (18 and 19) wherein the sprocket (19) is a fifth conductor of power and the sprocket (18) is a fifth driven power source, linked by a chain (34) to sprockets (18 and 19); the shaft (42) is configured to drive the sprockets (20 and 19); a high-speed timing gear, fourth conductor power source and the sprocket (20) configured to operate at a high-speed than any other gears in the system (17), and a high-speed driven timing gear (16), installed on the shaft of an alternator (11) configured to provide movement to a timing belt (33); said alternator (11) being an electrical power source being configured to generate and transmit power by an interconnection with the electrical panel, a power distribution board or an electrical substation configured to receive and transmit power; in combination with the mechanical system, configured to include an electrical control system that includes a control board (42), starters (43a and 43b), programmable logic controls (PLC) (44) and a power module (45) for starting; the batteries (47a, 47 b) and the capacitors (48a, 48b), frequency inverters or changing (VFD) (46a and 46b) connected to motors (8 and 9) configured to energize the vacuum pump that comprises the air filter (12); and vacuum pump being configuring to supply a volume of air to fill the buckets (7i-7q) disposed on the upward moving portion of the chain drive holding the buckets (7i-7q).

One feature or aspect of an exemplification is believed at the time of the filing of this patent application to possibly reside broadly in a transportable gravitational method for generating consistent electrical power and generating minimized pollution, using a transportable gravitational system comprising: a hydro-silo comprising a container being configured to contain up to about five meters of water column therein; a drive system being disposed inside said hydro-silo; a metal or steel reinforcement (1) being disposed around the exterior of said hydro-silo and to extend, starting from a base of the hydro-silo (2), upwards along about two-thirds of the exterior of said hydro-silo and; said hydro-silo comprising a drain (3) for the water; the hydro-silo (2) comprising an internal steel structure (4) that supports said drive system on a steel floor (6); almost at or adjacent an upper internal end of the hydro-silo (2) there is disposed a horizontal catwalk (5) around the internal metal structure (4) configured to permit maintenance work on the mechanical and electrical components of said drive system; said drive system comprising a vacuum pump comprising an air filter (12); said drive system comprising two batteries (47a, 47b), capacitors (48a, 48b), and an electrical power and control board (42) configured to turn on said drive system and initialize said vacuum pump with said air filter (12); said control board (42) comprising: starters (43a and 43b); a programmable logic controller (PLC) (44) and a power module (45) therefor, which said programmable logic controller (PLC) (44) being configured as said electronic processor of a motor control (8, 9) and operational equipment systems; and frequency inverters (VFD) (46a and 46b) connected to said motors (8 and 9) and configured to energize said vacuum pump with said air filter (12); said vacuum pump being configured to generate and supply air to a bottom part of said drive system through a pipe (13) comprising polyvinylchloride material and having an approximately 2-inch diameter; said pipe comprising a non-return valve that prevents water from flooding said pipe in its horizontal and ascending sections; said pipe comprising an air outlet and an expansion section in a 3-inch trident (13a, 13b, 13c); said trident being configured to, via air injection, quickly and completely fill said buckets disposed on an upwardly-moving side portion of said hydro-silo (7a-7q); said drive system comprising vertical parallel bucket chains (39a, 39b) being configured to be tightened by a screw system with proportional tension on both sides of said drive system; said drive system comprising a starting arrangement to move with the movement of said master sprocket (26) so that said master sprocket is configured to transmit said power to said upper transmission system; said sprocket (25) being configured to be driven by primary power and by a transmission chain and a master power conductor (38); said gear ratio, gears or gearbox comprising gear ratios in the range of approximately or exactly 1 to 3 (change of multiplying gear), which gear ratios are configured to increase by about 3 times said revolutions achieved by said master sprocket (26), such that an increase in the revolutions per minute (RPM) of said underwater drive shaft (28a, 28b) results; said shaft (28a) being configured to operate said sprockets (27a, 27b and 26); a set of sprockets (23, 24) being connected to transmit power, wherein said sprocket (24) is a secondary conductor of some power and said sprocket (23) is a secondary driven conductor (24) of power, with both said sprocket (23) and said sprocket (24) being configured to be driven by means of a chain (37); a shaft (29) of said sprockets (24 and 25) being the same and being configured to provide movement to a set of sprockets (21-22), wherein said sprocket (21) is a tertiary conductor of power and said sprocket (22) is a driven tertiary conductor of power driven by means of a chain and both said sprocket (21) and said sprocket (22) being connected by a chain (36); said shaft (30) being configured to drive said sprockets (21 and 23); a set of sprockets (20 and 49) where said sprocket (49) is a quaternary fourth conductor power source and said sprocket (20) is quaternary a fourth driven sprocket, wherein both said sprocket (49) and said sprocket (20) being linked by a chain (31); a further set of sprockets (18 and 19) wherein said sprocket (19) is a fifth conductor of power and said sprocket (18) is a fifth driven power source, linked by a chain (34) to sprockets (18 and 19); said shaft (42) being configured to drive said sprockets (20 and 19); a set of high-speed timing gears being configured to operate at a higher speed than any other gears in said system (17), and a high-speed driven timing gear (16) being installed on said shaft of an alternator (11) and being configured to provide movement to a timing belt (33); said alternator (11) being an electrical power source being configured to generate and transmit power by an interconnection with said electrical panel, a power distribution board or an electrical substation configured to receive and transmit power; and said vacuum pump being configured to supply a high volume of air to quickly and completely fill said buckets (7i-7q) disposed on said upward-moving portion of said chain drive holding said buckets (7i-7q); and said method comprising the steps of: starting the system using batteries or a power grid; filtering air from said air pump with said filter; bubbling air from said air pump into said buckets; starting the movement of said buckets and generating power from said alternator or a generator; and running the system and recharging the batteries.

One feature or aspect of an exemplification is believed at the time of the filing of this patent application to possibly reside broadly in the transportable gravitational method for generating consistent electrical power and generating minimized pollution, wherein: the primary speed regulator motor (8) comprises an electrical system comprising the motor of the vacuum pump (12) and the synchronous alternator (11); said electrical system is interconnected to a mechanical transmission of the generation system to provide sufficient supplementary torque to keep the alternator (11) within a nominal speed; said electrical system comprising a capacity being sufficient upon use of all of: motors, pumps and electrical equipment being interconnected during the in-rush startups; and the start up comprising a starting power or in-rush power comprising between 2 to times the nominal operating amperage during the start-up of said system to provide during the startup that the system comprises the ability to accelerate and balance this peak power demand.

One feature or aspect of an exemplification is believed at the time of the filing of this patent application to possibly reside broadly in the transportable gravitational method for generating consistent electrical power and generating minimized pollution, wherein: the system comprises a speed regulating system with feedback, wherein said feedback regulates the revolutions per minute (RPM) on the alternator (11), whereby the electrical power generated is essentially constant and comprises a ramp up within 1-5 seconds; and said method further comprises regulating speed of said revolutions per minute on the alternator (11).

One feature or aspect of an exemplification is believed at the time of the filing of this patent application to possibly reside broadly in the transportable gravitational method for generating consistent electrical power and generating minimized pollution, wherein: said batteries comprise zinc bromide (Br Zn) batteries (47a, 47b) being non-polluting batteries configured to start and sustain said system without external three-phase electric power to generate constant alternating current; whereby alternatively upon the system starting, said system is configured to support itself without being connected to any electric source, the synchronous alternator (11) comprising sufficient capacity to charge the batteries (47a, 47b) and condensers (48a, 48b); and said method further comprises: alternating a three-phase electric current to start or maintain the system; said zinc bromide batteries maintaining the system; and said condensers maintaining the system.

One feature or aspect of an exemplification is believed at the time of the filing of this patent application to possibly reside broadly in the transportable gravitational method for generating consistent electrical power and generating minimized pollution, wherein: the control board (42) uses two variable frequency drives (46a and 46b), two batteries to store electrical power (47a, 47b) in order to generate electrical power and start the system under any weather condition; the programmable logic controller (PLC) (44) and its power module (45) being disposed inside the electrical panel; the system comprising starters (43a and 43b) being disposed to connect with said speed control motors (8 and 9) being configured and disposed to be operated by said variable frequency drives; and using said variable frequency drivers to feed power to said motor.

One feature or aspect of an exemplification is believed at the time of the filing of this patent application to possibly reside broadly in the transportable gravitational method for generating consistent electrical power and generating minimized pollution, whereby said system being configured to start upon an optimum water level not being available for best operation and the start of electric power generation to provide a starting wherein between 5 and 15 seconds after starting the air volume filling process (7a-7q) with air, and upward movement of the buckets (7i-7q), and operating said system while the water level in the water container 2 is at a non-optimum water level.

One feature or aspect of an exemplification is believed at the time of the filing of this patent application to possibly reside broadly in the transportable gravitational method for generating consistent electrical power and generating minimized pollution, wherein said system comprises an 86% energy efficiency upon exciting a synchronous alternator (11) at 1,800 rpm (revolutions per minute) with the use of a single primary speed control motor (8) connected to 220V or 440V configured to regulate the speed of the electric power of the synchronous alternator (11), and operating said synchronous alternator 11 at 1800 RPM and generating 220 V or 440 V.

One feature or aspect of an exemplification is believed at the time of the filing of this patent application to possibly reside broadly in the transportable gravitational method for generating consistent electrical power and generating minimized pollution, wherein: the pump with air filter (12), sucks in atmospheric air, generating two bars of air pressure, and delivers the air through a PVC pipe (13), in a trident shape (13a, 13b, 13c) to the lower part of the hydro-silo (2); transferring a volume of air to the metal containers or buckets (7a-7q), and exerting an upward buoyant force sufficient for mechanical movement of the bucket drive chains (39a and 39b) of the system; the buckets' internal volume (7a-7q) filling approximately 90 to 98% of a capacity of the buckets; the vacuum pump (12) being connected to an electric motor to provide rotary motion; the pump (12) using the energy of the internal generation system at 440V; filling the buckets (7a-7q) with air and moving the drive chain (39a, 39b) on the upwardly-moving side; closing a number of the buckets configured to the generation capacity required by the system; and filling the buckets with air and driving said system and generating electricity.

One feature or aspect of an exemplification is believed at the time of the filing of this patent application to possibly reside broadly in the transportable gravitational method for generating consistent electrical power and generating minimized pollution, wherein: transferring all the available mechanical power of flotation to an upper section of the system, through at at least one of: gear ratios, gears or gearbox with ratios from 1 to 3 to increase by 3 times the revolutions achieved by the master sprocket (26) and increasing the rpm of the underwater drive shafts (28a and 28b) until the alternator reaches (11) the revolutions required to generate alternate current with the required voltage; increasing the revolutions per minute (RPM) of the underwater sprockets (27a, 27b, 27c, 27d) by means of a 1:300 ratio achieving an alternator speed of 1,800 RPM or more; using sprockets or chains or pulleys or belts; producing a custom-made speed multiplier gearbox to achieve the speed of 1,800 RPM; and rotating the underwater sprockets and providing a speed of 1800 RPM or more to the alternator 11.

One feature or aspect of an exemplification is believed at the time of the filing of this patent application to possibly reside broadly in the transportable gravitational method for generating consistent electrical power and generating minimized pollution, wherein: moving downward side buckets (7a-7q) of the bucket drive chains (39a and 39b) and flooding said buckets with water and generating a balance of dynamic loads; allowing the air trapped in the upward drive system to generate enough upward force to obtain mechanical torque that will be converted based on mechanical ratio of 1 to 3 and increasing the output speed revolutions per minute (rpm) to excite the alternator to 220 or 440 Volts (11); and flooding the downward moving the buckets with water.

One feature or aspect of an exemplification is believed at the time of the filing of this patent application to possibly reside broadly in the transportable gravitational method for generating consistent electrical power and generating minimized pollution, wherein: each bucket (7 a-7q) has a 1-inch high bubble leak barrier within the perimeter of air volume intake to minimize loss of buoyancy and upward mechanical power by not allowing or minimizing air escaping from the buckets (7 to-7q) while ascending; each bucket is fastened through a security fixing screw system and stainless-steel internal reinforcement plates; adjusting the buckets (7a-7q) in quantity and size, thereby increasing or decreasing the mechanical lift capacity through flotation and varying the power generation capacity expressed in KWh (kilo watt hours); and minimizing bubble leakage from each bucket with said 1 inch high bubble leak barrier.

One feature or aspect of an exemplification is believed at the time of the filing of this patent application to possibly reside broadly in the transportable gravitational method for generating consistent electrical power and generating minimized pollution, wherein: avoiding flotation of the descending buckets with level sensors and detecting the level of water column, and controlled with the PLC (44) on the control board and maintaining the buckets being always immersed under the water level in the water container and avoiding the flotation being unfavorable; and the system takes full advantage of the buoyant force of the bubbles or the volume of air suspended or trapped inside the buckets by fully utilizing the buoyant force of the bubbles or the volume of air suspended or trapped inside the buckets.

One feature or aspect of an exemplification is believed at the time of the filing of this patent application to possibly reside broadly in the transportable gravitational method for generating consistent electrical power and generating minimized pollution, wherein: maintaining with the motor speed control system the required revolutions per minute (rpm) when connecting equipment whose start-ups in-rush that require additional power and maintaining generated voltage within range to 440V or 220V and recovering within 1 to 5 seconds using the automated PLC internal speed control.

One feature or aspect of an exemplification is believed at the time of the filing of this patent application to possibly reside broadly in the transportable gravitational method for generating consistent electrical power and generating minimized pollution, wherein: upon turning ON, the system starts the simultaneous operation of a starter regulator motor (9) and a primary speed control motor (8); the starter motor (9) upon reaching high revolutions (the full speed of the system for its operation is 1,800 to 2,000 rpm), automatically turns off and leaving the primary speed control motor (8) ON for normal operating conditions and delivering power and energy; the primary speed control motor (8) remaining ON while the system is running and controlling and monitoring the speed of the system; ensuring the bucket drive system (7a-7q, 26, 27a, 27b, 27c, 27d, 28a, 28b, 39a, 39b) maintaining a constant speed on the mechanical movement ascending in the bucket drive chains (39a and 39b); managing higher or lower revolutions per minute (rpm), between 1800 and 2000 rpm, wherein the primary motor (8) performing the guide or index function; and the bucket drive system (26, 27a, 27b, 27c, 27d, 28a, 28b, 39a, 39b) being effectively slower than the bubble upward speed which is estimated to be at 25.5 cm/sec maximum.

One feature or aspect of an exemplification is believed at the time of the filing of this patent application to possibly reside broadly in the transportable gravitational method for generating consistent electrical power and generating minimized pollution, wherein: both motors (8 and 9) are interconnected by means of V-type belts through the drive pulleys (50 and 14 respectively) to the pulley, which is installed on the alternator shaft (40), with a double V-type pulley on the shaft of the alternator; an encoder (10) is installed on the alternator shaft; said encoder measuring the speed of the alternator arrow in real time and interconnected to a programmable logic control (PLC) (44) using frequency inverters (46a and 46b) (VFD) and starters (43a, 43b) to turn the motors ON or OFF; either generating more revolutions or turning off said system once the ROCA Regime has been reached or when the additional load is normalized (8, 9); start regulator motor (9) and another for the primary speed control motor (8) when the speed of the alternator (11) decreases below 1800 rpm; the programmable logic controller (44) (PLC) executes variable acceleration commands including acceleration or deceleration ramps and compensating the electrical load and achieving the revolutions per minute required by the synchronous alternator (11); upon the primary speed control motor by itself (8) not generating the required rpm (revolutions per minute), the starter motor (9) controlled by the programmable logic control (PLC) starting an acceleration ramp to support the primary speed control motor (8) and generating the required rpm (revolutions per minute) and establishing an operating regime again and restoring the automatic mode upon the start-up regulator motor (9) being put out of operation when normal operating conditions have been reached.

One feature or aspect of an exemplification is believed at the time of the filing of this patent application to possibly reside broadly in the transportable gravitational method for generating consistent electrical power and generating minimized pollution, wherein: capturing the volume of total instantaneous air in the buckets (7a-7q) and generating an upward force and converting the upward force into speed and torque; generating electrical energy according to the needs of the electrical installation receiving the power and controlling the speed of the primary speed control motor (8) by the programmable logic programmer (PLC) (44).

One feature or aspect of an exemplification is believed at the time of the filing of this patent application to possibly reside broadly in the transportable gravitational method for generating consistent electrical power and generating minimized pollution, wherein: the transportable mechanical system is located inside the hydro-silo or water container (2); and sensing when the hydro-silo or water container is empty and transporting said system by land, air or sea, without separating the system into pieces or dismantling, wherein a weight of said system when dry is about 8 tons.

One feature or aspect of an exemplification is believed at the time of the filing of this patent application to possibly reside broadly in the transportable gravitational method for generating consistent electrical power and generating minimized pollution, wherein: operating a low operational noise level using timing belts (33) in the high-speed pulleys (16, 17) and generating noise levels in decibels lower than 72 dB in the lower part of the system and lower than 93 dB in the upper part of the system.

One feature or aspect of an exemplification is believed at the time of the filing of this patent application to possibly reside broadly in the transportable gravitational method for generating consistent electrical power and generating minimized pollution, wherein: the system comprises membranes; said membranes permitting atmospheric pressure entering the hydro-silo (2), but preventing moisture from escaping from the container; and the system comprising a drip makeup water system compensating for any accumulated evaporation in substantial periods of accumulated operation. The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

All of the patents, patent applications, patent publications, and other documents, except for the exceptions indicated herein, which were cited in the International Search Report dated Aug. 27, 2018, and/or cited elsewhere, as well as the International Search Report document itself, are hereby incorporated by reference as if set forth in their entirety herein except for the exceptions indicated herein, as follows: WO 2017107502 A1; DE 102014019254 A1; U.S. Pat. No. 4,981,015 A; GB 2442786 A; and ES 2532519 A1.

The following patent publication is incorporated by reference as if set forth in their entirety herein: DE 102014016202, entitled “Process to make use of power take-off and wave energy with circulation of an endless number of chain conveyors that circulates in liquid floaters and apparatus.”

The corresponding international patent publication applications, namely, International Application No. PCT/MX2017/000167, filed on Dec. 19, 2017, having WIPO Publication No. WO2019/125110 and inventor(s) Luis WINTERGERST FISCH, is hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating International Application No. PCT/MX2017/000167 is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in International Application No. PCT/MX2017/000167 from which this patent application claims priority which do not have to do with the correction of the translation in this patent application are not to be included in this patent application in the incorporation by reference.

Any statements about admissions of prior art in International Application No. PCT/MX2017/000167 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. § 1.72(b). As stated in 37 C.F.R. § 1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

What is claimed is:

1. A transportable gravitational system for generating clean electrical power which is carried out inside a hydrosyl (water container) (2), with a metal reinforcement (1) starting from a base of the water container (2) upwards, and with a drain (3) for the water;
the hydrosyl (2) comprising an internal steel structure (4) that supports said mechanical system on a steel floor (6);
the hydrosyl (water container) (2) being configured to contain up to 5 meters of water column inside the hydrosyl (2);
adjacent an upper internal end of the hydrosyl (2) (water container) is disposed a horizontal catwalk (5) around the internal metal structure (4) configured to carry out maintenance work on the mechanical and electrical components of said system;
said system comprises two batteries (47a, 47b) and an electrical power and control board (42);
electrical switches inside a board (43a, 43b, 44, 45, 46a, 46b), comprise at least one of:
frequency inverters (VFD) (46a, 46b),
a programmable logic controller (PLC) (44); and
power module (45) for the programmable logic controller (PLC) (44) and configured as the electronic processor of a motor control (8,9) and
operational equipment systems;
the system is configured to be turned ON and begins a startup, and configured to be initialized with a vacuum pump which includes an air filter (12), the vacuum pump with the air filter (12) being configured to supply air to a bottom part of the mechanical system through a Polyvinyl Chloride pipe (13);
the pipe comprises a non-return valve that prevents water from flooding the PVC pipe in the pipe's horizontal and ascending sections, the pipe comprises an air outlet and expansion section in a trident (13a, 13b, 13c); the trident is configured to fill the buckets disposed on an upwardly moving side portion of the hydrosyl (7a-7q),
the vertical parallel bucket chains (39a, 39b), being configured to be tightened by a screw system with proportional tension on both sides of the drive system, the mechanical system comprising a starting arrangement to move the master sprocket (26) so that the master sprocket is configured to transmits the power to the upper transmission system;
the sprocket (25) configured to be driven by primary power, is configured to be driven by a transmission chain and a master power conductor (38);
the gear ratio, gears or gearbox comprising gear ratios of approximately or exactly 1 to 3 which gear ratios are configured to increase by about 3 times the revolutions achieved by the master sprocket (26), wherein an increase in the revolutions per minute (RPM) of the underwater drive shaft (28a, 28b) results;
the shaft (28a) is configured to operate the sprockets (27a, 27b and 26);
a set of sprockets (23, 24) connected to transmit power, wherein the sprocket (24) is a secondary conductor of power and the sprocket (23) is a secondary driven conductor (24) of power, with both the sprocket (23) and the sprocket (24) being configured to be driven by means of a chain (37);
the shaft (29) of the sprockets (24 and 25) is configured to provide movement to a set of sprockets (21-22), wherein the sprocket (21) is a tertiary conductor of power and the sprocket (22) is a driven tertiary conductor of power driven by means of a chain and both the sprocket (21) and the sprocket (22) being connected by a chain (36);
the shaft (30) being configured to drive the sprockets (21 and 23);
a set of sprockets (20 and 49) where the sprocket (49) is a fourth conductor power source and the sprocket (20) is a fourth driven sprocket; both the sprocket (49) and the sprocket (20) being linked by a chain (31);
a further set of sprockets (18 and 19) wherein the sprocket (19) is a fifth conductor of power and the sprocket (18) is a fifth driven power source, linked by a chain (34) to sprockets (18 and 19);
the shaft (42) is configured to drive the sprockets (20 and 19);
a high-speed timing gear, fourth conductor power source and the sprocket (20) configured to operate at a high-speed than any other gears in the system (17), and a high-speed driven timing gear (16), installed on the shaft of an alternator (11) configured to provide movement to a timing belt (33);
said alternator (11) being an electrical power source being configured to generate and transmit power by an interconnection with the electrical panel, a power distribution board or an electrical substation configured to receive and transmit power;
in combination with the mechanical system, configured to include an electrical control system that includes a control board (42), starters (43a and 43b), programmable logic controls (PLC) (44) and a power module (45) for starting;
the batteries (47a, 47 b) and the capacitors (48a, 48b), frequency inverters or changing (VFD) (46a and 46b) connected to motors (8 and 9) configured to energize the vacuum pump that comprises the air filter (12); and
vacuum pump being configuring to supply a volume of air to fill the buckets (7i-7q) disposed on the upward moving portion of the chain drive holding the buckets (7i-7q).

2. A transportable gravitational method for generating consistent electrical power and generating minimized pollution, using a transportable gravitational system comprising:
a hydro-silo comprising a container being configured to contain up to about five meters of water column therein;
a drive system being disposed inside said hydro-silo;
a metal or steel reinforcement (1) being disposed around the exterior of said hydro-silo and to extend, starting from a base of the hydro-silo (2), upwards along about two-thirds of the exterior of said hydro-silo and;
said hydro-silo comprising a drain (3) for the water;
the hydro-silo (2) comprising an internal steel structure (4) that supports said drive system on a steel floor (6);
almost at or adjacent an upper internal end of the hydro-silo (2) there is disposed a horizontal catwalk (5) around the internal metal structure (4) configured to permit maintenance work on the mechanical and electrical components of said drive system;
said drive system comprising a vacuum pump comprising an air filter (12);
said drive system comprising two batteries (47a, 47b), capacitors (48a, 48b), and an electrical power and control board (42) configured to turn on said drive system and initialize said vacuum pump with said air filter (12);
said control board (42) comprising:
starters (43a and 43b);
a programmable logic controller (PLC) (44) and a power module (45) therefor, which said programmable logic controller (PLC) (44) being configured as said electronic processor of a motor control (8, 9) and operational equipment systems; and
frequency inverters (VFD) (46a and 46b) connected to said motors (8 and 9) and configured to energize said vacuum pump with said air filter (12);
said vacuum pump being configured to generate and supply air to a bottom part of said drive system through a pipe (13) comprising polyvinylchloride material and having an approximately 2-inch diameter;
said pipe comprising a non-return valve that prevents water from flooding said pipe in its horizontal and ascending sections;
said pipe comprising an air outlet and an expansion section in a 3-inch trident (13a, 13b, 13c);
said trident being configured to, via air injection, quickly and completely fill said buckets disposed on an upwardly-moving side portion of said hydro-silo (7a-7q);
said drive system comprising vertical parallel bucket chains (39a, 39b) being configured to be tightened by a screw system with proportional tension on both sides of said drive system;
said drive system comprising a starting arrangement to move with the movement of said master sprocket (26) so that said master sprocket is configured to transmit said power to said upper transmission system;
said sprocket (25) being configured to be driven by primary power and by a transmission chain and a master power conductor (38);
said gear ratio, gears or gearbox comprising gear ratios in the range of approximately or exactly 1 to 3 (change of multiplying gear), which gear ratios are configured to increase by about 3 times said revolutions achieved by said master sprocket (26), such that an increase in the revolutions per minute (RPM) of said underwater drive shaft (28a, 28b) results;
said shaft (28a) being configured to operate said sprockets (27a, 27b and 26);
a set of sprockets (23, 24) being connected to transmit power, wherein said sprocket (24) is a secondary conductor of some power and said sprocket (23) is a secondary driven conductor (24) of power, with both said sprocket (23) and said sprocket (24) being configured to be driven by means of a chain (37);
a shaft (29) of said sprockets (24 and 25) being the same and being configured to provide movement to a set of sprockets (21-22), wherein said sprocket (21) is a tertiary conductor of power and said sprocket (22) is a driven tertiary conductor of power driven by means of a chain and both said sprocket (21) and said sprocket (22) being connected by a chain (36);
said shaft (30) being configured to drive said sprockets (21 and 23);
a set of sprockets (20 and 49) where said sprocket (49) is a quaternary fourth conductor power source and said sprocket (20) is quaternary a fourth driven sprocket, wherein both said sprocket (49) and said sprocket (20) being linked by a chain (31);
a further set of sprockets (18 and 19) wherein said sprocket (19) is a fifth conductor of power and said sprocket (18) is a fifth driven power source, linked by a chain (34) to sprockets (18 and 19);
said shaft (42) being configured to drive said sprockets (20 and 19);
a set of high-speed timing gears being configured to operate at a higher speed than any other gears in said system (17), and a high-speed driven timing gear (16) being installed on said shaft of an alternator (11) and being configured to provide movement to a timing belt (33);
said alternator (11) being an electrical power source being configured to generate and transmit power by an interconnection with said electrical panel, a power distribution board or an electrical substation configured to receive and transmit power; and
said vacuum pump being configured to supply a high volume of air to quickly and completely fill said buckets (7i-7q) disposed on said upward-moving portion of said chain drive holding said buckets (7i-7q); and
said method comprising the steps of:
starting the system using batteries or a power grid;
filtering air from said air pump with said filter;
bubbling air from said air pump into said buckets;
starting the movement of said buckets and generating power from said alternator or a generator; and
running the system and recharging the batteries.

3. The transportable gravitational method for generating consistent electrical power and generating minimized pollution according to claim 2, wherein:
the primary speed regulator motor (8) comprises an electrical system comprising the motor of the vacuum pump (12) and the synchronous alternator (11);
said electrical system is interconnected to a mechanical transmission of the generation system to provide sufficient supplementary torque to keep the alternator (11) within a nominal speed;
said electrical system comprising a capacity being sufficient upon use of all of: motors, pumps and electrical equipment being interconnected during the in-rush startups; and
the start up comprising a starting power or in-rush power comprising between 2 to 3 times the nominal operating amperage during the start-up of said system to provide during the startup that the system comprises the ability to accelerate and balance this peak power demand.

4. The transportable gravitational method for generating consistent electrical power and generating minimized pollution according to claim 3, wherein:
the system comprises a speed regulating system with feedback, wherein said feedback regulates the revolutions per minute (RPM) on the alternator (11), whereby the electrical power generated is essentially constant and comprises a ramp up within 1-5 seconds; and
said method further comprises regulating speed of said revolutions per minute on the alternator (11).

5. The transportable gravitational method for generating consistent electrical power and generating minimized pollution according to claim 4, wherein:
said batteries comprise zinc bromide (Br Zn) batteries (47a, 47b) being non-polluting batteries configured to start and sustain said system without external three-phase electric power to generate constant alternating current;
whereby alternatively upon the system starting, said system is configured to support itself without being connected to any electric source, the synchronous alternator (11) comprising sufficient capacity to charge the batteries (47a, 47b) and condensers (48a, 48b); and
said method further comprises:
alternating a three-phase electric current to start or maintain the system;
said zinc bromide batteries maintaining the system; and
said condensers maintaining the system.

6. The transportable gravitational method for generating consistent electrical power and generating minimized pollution according to claim 5, wherein:
the control board (42) uses two variable frequency drives (46a and 46b), two batteries to store electrical power (47a, 47b) in order to generate electrical power and start the system under any weather condition;
the programmable logic controller (PLC) (44) and its power module (45) being disposed inside the electrical panel;
the system comprising starters (43a and 43b) being disposed to connect with said speed control motors (8 and 9) being configured and disposed to be operated by said variable frequency drives; and
using said variable frequency drivers to feed power to said motor.

7. The transportable gravitational method for generating consistent electrical power and generating minimized pollution according to claim 6, whereby said system being configured to start upon an optimum water level not being available for best operation and the start of electric power generation to provide a starting wherein between 5 and 15 seconds after starting the air volume filling process (7a-7q) with air, and upward movement of the buckets (7i-7q), and operating said system while the water level in the water container 2 is at a non-optimum water level.

8. The transportable gravitational method for generating consistent electrical power and generating minimized pollution according to claim 7, wherein said system comprises an 86% energy efficiency upon exciting a synchronous alternator (11) at 1,800 rpm (revolutions per minute) with the use of a single primary speed control motor (8) connected to 220V or 440V configured to regulate the speed of the electric power of the synchronous alternator (11), and operating said synchronous alternator 11 at 1800 RPM and generating 220 V or 440 V.

9. The transportable gravitational method for generating consistent electrical power and generating minimized pollution according to claim 8, wherein:
the pump with air filter (12), sucks in atmospheric air, generating two bars of air pressure, and delivers the air through a PVC pipe (13), in a trident shape (13a, 13b, 13c) to the lower part of the hydro-silo (2);
transferring a volume of air to the metal containers or buckets (7a-7q), and exerting an upward buoyant force sufficient for mechanical movement of the bucket drive chains (39a and 39b) of the system;
the buckets' internal volume (7a-7q) filling approximately 90 to 98% of a capacity of the buckets;
the vacuum pump (12) being connected to an electric motor to provide rotary motion;
the pump (12) using the energy of the internal generation system at 440V;
filling the buckets (7a-7q) with air and moving the drive chain (39a, 39b) on the upwardly-moving side;
closing a number of the buckets configured to the generation capacity required by the system; and
filling the buckets with air and driving said system and generating electricity.

10. The transportable gravitational method for generating consistent electrical power and generating minimized pollution according to claim 9, wherein:
transferring all the available mechanical power of flotation to an upper section of the system, through at at least one of: gear ratios, gears or gearbox with ratios from 1 to 3 to increase by 3 times the revolutions achieved by the master sprocket (26) and increasing the rpm of the underwater drive shafts (28a and 28b) until the alternator reaches (11) the revolutions required to generate alternate current with the required voltage;
increasing the revolutions per minute (RPM) of the underwater sprockets (27a, 27b, 27c, 27d) by means of a 1:300 ratio achieving an alternator speed of 1,800 RPM or more;
using sprockets or chains or pulleys or belts;
producing a custom-made speed multiplier gearbox to achieve the speed of 1,800 RPM; and
rotating the underwater sprockets and providing a speed of 1800 RPM or more to the alternator 11.

11. The transportable gravitational method for generating consistent electrical power and generating minimized pollution according to claim 10, wherein:
moving downward side buckets (7a-7q) of the bucket drive chains (39a and 39b) and flooding said buckets with water and generating a balance of dynamic loads;
allowing the air trapped in the upward drive system to generate enough upward force to obtain mechanical torque that will be converted based on mechanical ratio of 1 to 3 and increasing the output speed revolutions per minute (rpm) to excite the alternator to 220 or 440 Volts (11); and
flooding the downward moving the buckets with water.

12. The transportable gravitational method for generating consistent electrical power and generating minimized pollution according to claim 11, wherein:
each bucket (7 a-7q) has a 1-inch high bubble leak barrier within the perimeter of air volume intake to minimize loss of buoyancy and upward mechanical power by not allowing or minimizing air escaping from the buckets (7 to-7q) while ascending;
each bucket is fastened through a security fixing screw system and stainless-steel internal reinforcement plates;
adjusting the buckets (7a-7q) in quantity and size, thereby increasing or decreasing the mechanical lift capacity through flotation and varying the power generation capacity expressed in KWh (kilo watt hours); and
minimizing bubble leakage from each bucket with said 1 inch high bubble leak barrier.

13. The transportable gravitational method for generating consistent electrical power and generating minimized pollution according to claim 12, wherein:
avoiding flotation of the descending buckets with level sensors and detecting the level of water column, and controlled with the PLC (44) on the control board and maintaining the buckets being always immersed under the water level in the water container and avoiding the flotation being unfavorable; and
the system takes full advantage of the buoyant force of the bubbles or the volume of air suspended or trapped inside the buckets by fully utilizing the buoyant force of the bubbles or the volume of air suspended or trapped inside the buckets.

14. The transportable gravitational method for generating consistent electrical power and generating minimized pollution according to claim 13, wherein maintaining with the motor speed control system the required revolutions per minute (rpm) when connecting equipment whose start-ups in-rush that require additional power and maintaining generated voltage within range to 440V or 220V and recovering within 1 to 5 seconds using the automated PLC internal speed control.

15. The transportable gravitational method for generating consistent electrical power and generating minimized pollution according to claim 14, wherein:
upon turning ON, the system starts the simultaneous operation of a starter regulator motor (9) and a primary speed control motor (8);
the starter motor (9) upon reaching high revolutions (the full speed of the system for its operation is 1,800 to 2,000 rpm), automatically turns off and leaving the primary speed control motor (8) ON for normal operating conditions and delivering power and energy;
the primary speed control motor (8) remaining ON while the system is running and controlling and monitoring the speed of the system;
ensuring the bucket drive system (7a-7q, 26, 27a, 27b, 27c, 27d, 28a, 28b, 39a, 39b) maintaining a constant speed on the mechanical movement ascending in the bucket drive chains (39a and 39b);
managing higher or lower revolutions per minute (rpm), between 1800 and 2000 rpm, wherein the primary motor (8) performing the guide or index function; and
the bucket drive system (26, 27a, 27b, 27c, 27d, 28a, 28b, 39a, 39b) being effectively slower than the bubble upward speed which is estimated to be at 25.5 cm/sec maximum.

16. The transportable gravitational method for generating consistent electrical power and generating minimized pollution according to claim 15, wherein:
both motors (8 and 9) are interconnected by means of V-type belts through the drive pulleys (50 and 14 respectively) to the pulley, which is installed on the alternator shaft (40), with a double V-type pulley on the shaft of the alternator;
an encoder (10) is installed on the alternator shaft;
said encoder measuring the speed of the alternator arrow in real time and interconnected to a programmable logic control (PLC) (44) using frequency inverters (46a and 46b) (VFD) and starters (43a, 43b) to turn the motors ON or OFF;
either generating more revolutions or turning off said system once the ROCA Regime has been reached or when the additional load is normalized (8, 9);
start regulator motor (9) and another for the primary speed control motor (8) when the speed of the alternator (11) decreases below 1800 rpm;
the programmable logic controller (44) (PLC) executes variable acceleration commands including acceleration or deceleration ramps and compensating the electrical load and achieving the revolutions per minute required by the synchronous alternator (11);
upon the primary speed control motor by itself (8) not generating the required rpm (revolutions per minute), the starter motor (9) controlled by the programmable logic control (PLC) starting an acceleration ramp to support the primary speed control motor (8) and generating the required rpm (revolutions per minute) and establishing an operating regime again and restoring the automatic mode upon the start-up regulator motor (9) being put out of operation when normal operating conditions have been reached.

17. The transportable gravitational method for generating consistent electrical power and generating minimized pollution according to claim 16, wherein:
capturing the volume of total instantaneous air in the buckets (7a-7q) and generating an upward force and converting the upward force into speed and torque;
generating electrical energy according to the needs of the electrical installation receiving the power and controlling the speed of the primary speed control motor (8) by the programmable logic programmer (PLC) (44).

18. The transportable gravitational method for generating consistent electrical power and generating minimized pollution according to claim 17, wherein:
the transportable mechanical system is located inside the hydro-silo or water container (2); and
sensing when the hydro-silo or water container is empty and transporting said system by land, air or sea, without separating the system into pieces or dismantling, wherein a weight of said system when dry is about 8 tons.

19. The transportable gravitational method for generating consistent electrical power and generating minimized pollution according to claim 18, wherein operating a low operational noise level using timing belts (33) in the high-speed pulleys (16, 17) and generating noise levels in decibels lower than 72 dB in the lower part of the system and lower than 93 dB in the upper part of the system.

20. The transportable gravitational method for generating consistent electrical power and generating minimized pollution according to claim 19, wherein:
the system comprises membranes;
said membranes permitting atmospheric pressure entering the hydro-silo (2), but preventing moisture from escaping from the container; and
the system comprising a drip makeup water system compensating for any accumulated evaporation in substantial periods of accumulated operation.
